(19) United States
(12) Patent Application Publication
(10) Pub. No.: US 2024/0352201 A1
(43) Pub. Date: Oct. 24, 2024

(54) Process and Apparatus for Curing Glass-fiber Paper Composites

(71) Applicant: UMICORE AG & CO. KG, Hanau-Wolfgang (DE)

(72) Inventors: Barry van Setten, Bad Soden-Salmünster (DE); Etienne Haubrichs, Hanau (DE); Thomas Holten Kollin, Husum (DK)

(73) Assignee: UMICORE AG & CO. KG, Hanau-Wolfgang (DE)

(21) Appl. No.: 18/302,439

(22) Filed: Apr. 18, 2023

(51) Int. Cl. C08J 5/04

(52) U.S. Cl. CPC C08J 5/043

(57) ABSTRACT

The present invention is concerned with a process and an apparatus for the production of glass-fiber paper composites. The process and apparatus of the invention analyze the color of the composite in order to monitor the curing condition of the composite and regulate the processing accordingly.

The present invention is concerned with a process and an apparatus for the production of glass-fiber paper composites. The process and apparatus of the invention analyze the color of the composite in order to monitor the curing condition of the composite and regulate the processing accordingly.

Glass-fibers are readily known materials (https://en.wikipedia.org/w/index.php?title=Glass_fiber&oldid=1121945870). They can be found in numerous applications. Composites of glass-fibers and polymers so called GFPs or GFRPs are standard materials in industry. In addition, composite materials made out of glass-fibers and paper are also used commercially, e.g. in the construction of support bodies, like honeycombs for catalytic processes (e.g. WO2010066345A1).

Such a corrugated monolith consists of alternating layers of flat and wavy sheets with regular curved folds or grooves (FIG. 2). Through winding or stacking of the combined flat and wavy sheets to a desired form, channels are created in the wavy layer of the article. In principle, such a structure can be made of any material that can be formed, combined to, and retain such a structure, e.g metal, ceramics, paper sheets, polymers, glass fiber sheets. To stabilize the structure, one or more further processing steps may be necessary, such as welding, soldering, glue, coating, heating. Such corrugated substrates and their manufacture out of glass-fiber paper composites are disclosed in CN104226373A, WO2010066345A1 US2010254864, U.S. Pat. No. 7,101,602, EP0988892, EP0919280, and U.S. Pat. No. 6,689,328 for example, and the teaching thereof can be applied to the present invention without departing from the scope of the claims. By applying a catalytically active material on the surface of the channels or in the porous structure of these materials, a corrugated catalytic article is obtained.

The corrugated substrates are normally made from sheets of E-glass fibers or from sheets of a glass with high silicon content and optionally with a layer of TiO₂ or diatomaceous earth. The high silicon content glass contains 94-95% by weight SiO₂, 4-5% by weight Al₂O₃ and some Na₂O, these fibers have a density of 2000-2200 g/L with a fiber diameter of 8-10 μm. An example is the commercially available SILEX® staple fiber. The E-glass contains 52-56% by weight SiO₂, 12-16% by weight Al₂O₃, 5-10% by weight B₂O₃, 0-1.5% by weight TiO₂, 0-5% by weight MgO, 16-25% by weight CaO, 0-2% by weight K₂O/Na₂O and 0-0.8% by weight Fe₂O₃. The material of the substrate is chosen in a manner that the density of the substrate is at least 50 g/L, but not higher than 300 g/L material, and the porosity of the substrate wall is at least 50% by volume of the material. The porosity of the monolithic substrate is obtained by the pores, which have a depth between 50 μm and 200 μm and a diameter between 1 μm and 30 μm.

The glass fiber paper is normally composed of two layers, the “liner” and the “waver” (FIG. 2). Both layers are manufactured according to the same principle. Each layer consists of a high number of glass fibers that are woven together and bonded by an organic. The liner is a flat layer of the paper. The waver is created by forming a liner into a wave-like shape. For the glass fiber paper considered here, the liner and waver are bonded together. This is done using an organic glue, which is applied in the form of glue points between the liner and the waver. The curing process hardens the paper and is intended to increase its stability. A side effect of the temperature treatment is the color change of the paper due to the curing of the glue.

The process for preparing such corrugated substrates necessitates that the glass-fiber paper is cured in an oven at elevated temperatures. The curing process changes the compressive strength, the main characteristic of the glass-fiber paper composite. Compressive strength is the strength until the waved glass-fiber paper composite “collapses”. It is calculated by dividing the measured force by the contact area on the waver and has therefore the unit N/mm². To calculate it one takes the length of a stamp used to crush the waves and multiply it with the distance between the outer “valleys” of the waves (see the so called Concora Medium Test (CMT) which is used in the paper and carton industry has a similar goal but is performed in a different way (no stamp); Link: https://industrialphysics.com/de/wissenbasis/artikell/technische-tipps-fuer-pruefer-serie-corrugated-002-ersetzen-des-concora-medium-tests-cmt-durch-den-neuen-s-test/).

If the paper is kept too long at a too high temperature, the curing affects the stability in a negative way. Until now, the quality of the glass-fiber paper composite could only be tested via compressive strength tests after the final process. An in-line control of the mechanical strength via this approach is not possible. To intensify the curing process it is desired to run the curing process at a higher temperature and a shorter contact time. However, for this an in-line mechanical stability measurement is required.

According to US20120271445A1 an in-line controlled process for curing glass fiber papers is disclosed. Based on control variables, like color values of the cured product, a closed loop control of the curing oven is performed. As an example the B-values in the CIE LAB-system are taken from an image of the cured product. A processor analyses the data and a corresponding algorithm adjust the oven controls to improve the cure status by e.g. adjusting the oven temperature, fan speed or coolant water flow.

The present invention is directed to a production process and an apparatus which solves the above mentioned problems according to independent claim 1 and X. Claims being dependent from these are directed towards preferable embodiments of the present invention.

In that one proposes a process for the production of glass-fiber paper composites having a desired compressive strength comprising the following steps in sequential order:
i. subjecting a non-cured glass-fiber paper composite to a curing process under curing conditions of elevated temperatures and respective dwell time to establish a desired compressive strength within the composite;
ii. irradiating the cured composite with light, in particular UV, Blue, Green, and scanning the cured composite with a respective detector;
iii. analyzing the outcome of step ii. by an electronic control unit being programmed to decide whether said curing conditions have to be adjusted or whether further curing of the composite is to be initiated or a reject is detected; and
iv. if the curing conditions have to be adjusted based on the data generated under iii. adjust the time of the curing process in an automatic closed-loop control format, the invention is completed and solves the problem of direct control of the strength of the just cured glass-fiber paper composites. It is a surprise that there seems to be a correlation between the color of the cured parts and the intensity of curing and thus the compressive strengths. By applying this correlation starting from the color of the part one is able to determine its curing status and thus its compressive strength. Optimized compressive strengths can be produced by an in-line control of the curing time used. This was all but obvious in light of the known prior art.

The glass-fiber paper composite having the correct compressive strength can then be rendered into advantageous corrugated articles as mentioned in the introduction. As explained, the compressive strength plays an important role here. It is preferable if the compressive strength of the glass-fiber paper is between 0.1-1.49, more preferred 0.15-1.79 and most preferred between 0.18-0.22 N/mm². These values are measured as explained in more detail before.

As already mentioned there is a correlation between the curing level and the color of the glass-fiber paper composite being or having been cured. To identify the correct curing state the skilled person first has to identify the correlation which may be different from product to product, because each product may have its own recipe of chemical ingredients, and thus its own color-curing dependency.

In order to find a most sensitive correlation the illumination or irradiation of the glass-fiber paper composite being or having been cured can be done with extremely bright light. The skilled person knows what to use here. Preferably, the irradiation is done with a spot light or line lighting device (https://www.keyence.com/products/vision/vision-sys/line_scan/models/ca-dzw50x/). The skilled person knows how to illuminate the products.

Another aspect when talking about irradiation is the wavelength of the light used. The skilled worker can choose the most appropriate wavelength for the most sensitive analysis within the visible range. At minimum one wavelength is used in this respect but more wavelengths, e.g. 2-5, more preferably 3-4, can also be used according to the benefit of the measurement. After having chosen the right intensity and the right wavelength(s) for the measurement the results obtained should be such that influences from other light emitting sources in the production plant can be neglected. In general, best peak waves used for illumination are selected from UV (around 405 nm), Blue (around 457 nm) and Green (around 527 nm).

The light reflected by the glass-fiber paper composite is then scanned with an appropriate detector. As such, e.g. matrix-cameras (e.g. Keyence VJ-HO48MX) and line scanners (e.g. Keyence CA-HLO8MX) can be used. The distance and angle depends on the camera system used (matrix or line, resolution) and the area that must be covered. E.g., for the Keyence CA-HLO8MX line scanner with a CA-LHT35 objective the working distance is 60 cm to cover the complete width of a corrugated paper with a width of 45 cm. The illumination device (e.g. Keyence CA-DZW45) sits closer to the paper to enable a correct illumination. The exact distance depends on the ambient conditions and the used wavelengths. The person skilled in the art knows how to detect the reflections from the glass-fiber paper composite best. The light emission and the detection of the image or the scan should be synchronized in a way that the detection takes place at the moment where the paper is correctly illuminated by the illumination device so that the ambient conditions (e.g. sunlight) have no influence on the image quality. This can be achieved by using a detection and illumination system that supports real-time processing (e.g. the industry wide GiGE Vision standard) and can therefore be synchronized very well (e.g. Keyence VJ-HO48MX camera with Keyence CA-DRM10X Flash unit via the GigE Vision compatible Keyence VJ3000 Image acquisition controller VJ3000).

In an alternative manner, a real-time lightning system can preferably be used that is fully synchronized with the camera which flashes at the required wavelengths (it may also be possible to make multiple images at multiple wavelengths and combine these images in real-time). The intensity of the flash should preferably be strong enough that ambient light conditions do not influence the result of the analysis. For the camera system different cameras are possible e.g., a line scanner (2k,4k,8k (e.g. CA-HLO8MX) pixels etc.) or a matrix camera with a rectangular image sensor (e.g., 512×480 pixels, 1980×1080, 100×100 etc.), e.g. a Keyence VJ-HO48MX with 784×596 or a Keyence VJ-H500MX with 2432×2040 pixels. In a preferred aspect the detector for scanning the composite is selected from the group of line scanners, cameras, Keyence VJ-Series (matrix cameras: https://www.keyence.de/products/vision/vision-sys/vj/models/vj-h048mx/) or Keyence CA-series (line scanners: https://www.keyence.de/products/vision/vision-sys/vj/models/ca-hl08mx/).

The images or values produced by the detector are then analyzed by an appropriately programmed electronic control unit. This unit then categorizes according to the correlation mentioned above whether further curing of the composite is to be initiated, other curing conditions are to be applied, in particular for following parts, or a reject is detected. This outcome is then either signaled to an operator, who can react accordingly, or, if conditions need to be adjusted is used to run the process in an automatic closed-loop control format. The curing conditions that are then influenced by the measurement directly. The curing time is adjusted by changing the belt speed. Hence, such a process where a camera or an appropriate line-scanner is embedded in a PLC (programmable logic controller) serves that all of the glass-fiber paper composite that passes the plant are (constantly) monitored in real-time and feedback is given to the process controller in real-time within the PLC so a closed-loop control is realized.

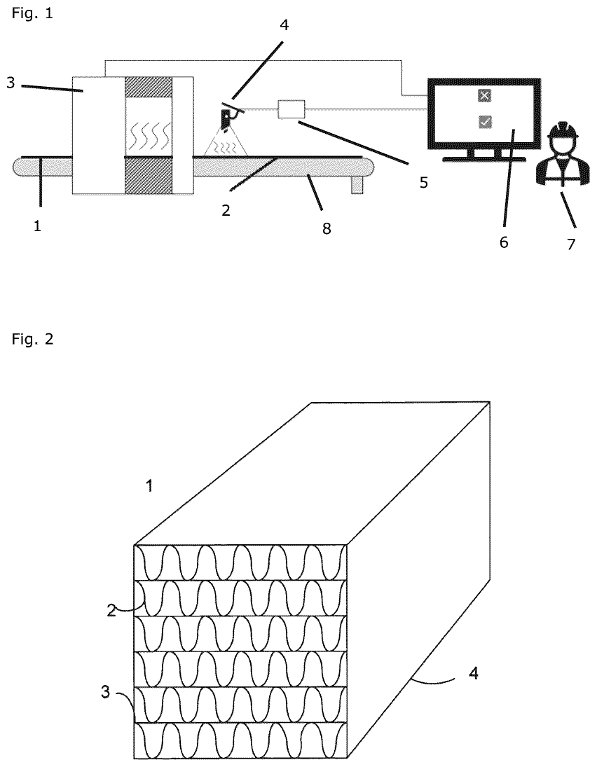

In a further aspect the present invention is concerned with an apparatus for performing the process just explained comprising:
a. device for heat treating a glass-fiber paper composite;
b. a light emitting device, in particular UV, blue, green-light emitting device;
c. a respective detector for scanning the composite;
d. an electronic control unit which is programmed to analyze the outcome of step c. in a sense to decide whether said curing conditions have to be adjusted or whether further curing of the composite is to be initiated or a reject is detected, wherein the apparatus is arranged to adjust the time of curing process based on the data generated under d. in an automatic closed-loop control format. Such a system and the process is schematically displayed in FIG. 1. Preferred embodiments mentioned for the respective process are likewise applicable to the apparatus mutatis mutandis.

In the present invention, the important factor besides the compressive strength of the glass-fiber paper composites is that their curing at elevated temperatures also changes the color intensity of the paper. In the invented procedure the correlation between the compressive strength and the color intensity is used as a quality feature in a monitoring process for curing glass-fiber paper composites. If the cured paper is correctly illuminated, the color intensities of the paper are detectable with a camera or the like. The wavelength(s) of light to be used may vary depending on the chemicals in the paper. The analysis is done in an electronic control unit and the regulation of the curing time in a closed-loop process control format. Here direct feedback is given to an electronic process controller that automatically adapts the curing conditions of belt speed. Alternatively, the production line operator is informed via the process control system if other curing conditions, like contact time and oven temperature need to be adjusted. It can also be detected if there are unwanted fluctuations in the process or the chemicals (e.g., change in quality of chemicals, one of the heating elements in the oven fails etc.) that lead to inhomogeneous curing conditions (e.g., local hotspots or temperature gradients) which can be detected by the camera too and the operator can be informed to take the required actions to solve the issue.

FIG. 1:

1 non-cured glass-fiber paper composite on a belt

2: cured glass-fiber paper composite on a belt

3: oven

4: lightning and camera device

5: electronic control unit that automatically analyzes the images and gives feedback to the plant operator. When quality issues arise the ECU makes automatically snapshots for later analysis of the problem; alternatively te belt speed of the curing oven is adjusted accordingly in a closed-loop control format.

6: monitor

7: operator

FIG. 2:

FIG. 2 shows a catalyst 1 in a shape box. It consists of corrugated (waved) plates 2, which are supported and separated from each other by plates 3, and the plates are mounted in a shell 4.

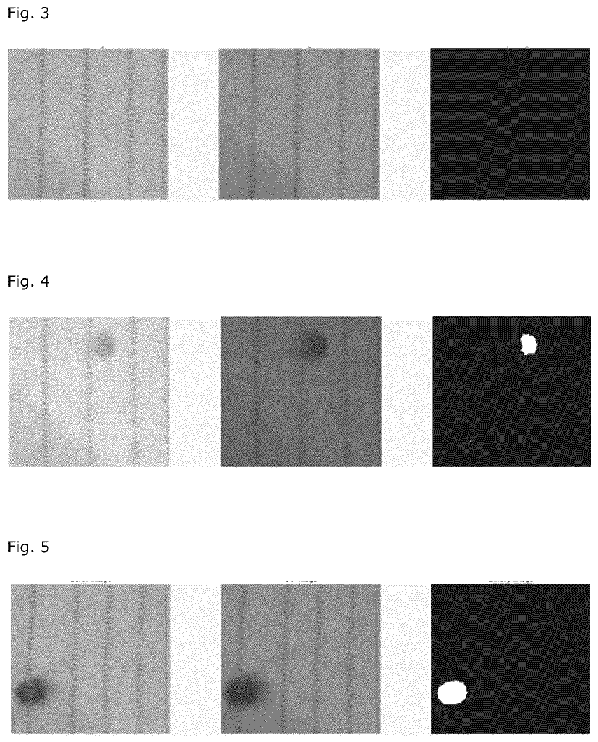

FIG. 3-8: Different glass-fiber paper composites cured under different conditions.

### EXPERIMENTS

### Experiment 1: Wavelength

### Description

The paper passed the oven as described in FIG. 1. The camera shot images of paper that was cured at different times and temperatures. During this test 8 different wavelengths (λ=330 to 930 nm) were used for the illumination of the paper. With UV lightning (λ≈380 nm) the camera can detect the color differences between several process conditions very precisely. Using Blue (λ≈450 nm) and Green (λ≈520 nm) the differences can be recorded precisely enough for a meaningful analysis.

With Infrared (λ≈850 nm) the camera cannot detect differences in the color. With Far-red, Red, Amber and White illumination differences can be detected but not precisely.

For the paper mentioned in the description UV, Blue and Green illumination can be used for meaningful analysis. If one or several of the components of the paper are changed other wavelengths could become more precisely.

### Experiment 2: Algorithm Confirm that Paper has a High Quality

### Description

The analysis algorithm (programmed with MATLAB-MathWorkshttps://de.mathworks.com/products/matlab.html makes 3 checks:

It detects all pixels on the paper where the intensity is lower 70 (dark spots). If the number of these pixels is higher than 1% of the total number of pixels the algorithm returns a warning. The operator should be now aware of that something is wrong and consider the next 2 checks. The mark where the algorithm gives a warning was set to 1% but can be defined different (e.g. 5%, 10% etc.) according to the requirements and maybe customer definitions.

It detects if there are hotspots, so areas of pixels with an intensity lower 70 that are larger as the maximum allowed size of hotspots. When a hotspot is detected the algorithm returns a warning and stops the conveyer belt because there is a problem that leads to hotspots which cannot be corrected via the process conditions time and temperature

It calculates the median intensity of the image. If the median intensity is lower as the intensity where the compressive strength/stability of the paper starts to drop the algorithm returns a warning and lowers the temperature and/or increases the belt speed.

A high quality paper (no hotspots, correct visible color) was checked in FIG. 3. Left one is a color image. Middle one is a UV image and right one is a binary image. For understanding: In the binary image (right image) black pixels mean that the intensity is >70 and therefore absolutely fine. White pixels mean that the intensity is <70 and therefore to low. The algorithm shows that there are no problems and the paper meets the requirements.

### Experiment 3: Algorithm Detects a Hotspot

### Description

The algorithm detects a hotspot and therefore stops the conveyor belt. A hotspot can be detected although the median intensity and the total number of dark spots are in tolerance (FIG. 4). Left one is a color image. Middle one is a UV image and right one is a binary image.

### Experiment 4: Algorithm Detects a Large Hotspot

### Description

The algorithm detects a hotspot and therefore stops the conveyor belt. The hotspot is large enough so that the total number of dark spots is higher as the tolerance (FIG. 5). Left one is a color image. Middle one is a UV image and right one is a binary image.

### Experiment 5: Algorithm Detects Several Hotspots

### Description

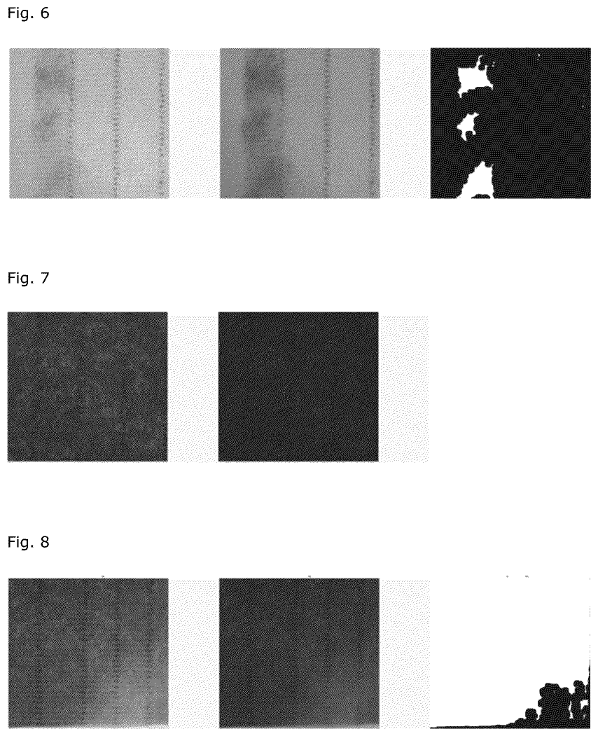

The algorithm detects several hotspots and therefore stops the conveyor belt. In total the area of the hotspots is larger as the tolerance allows (FIG. 6). Left one is a color image. Middle one is a UV image and right one is a binary image.

### Experiment 6: Algorithm Detects to High Median Intensity

### Description

In a test the algorithm detects that the median intensity is lower 70 and therefore increases the conveyer belt. In a production site alternatively the oven temperature could be reduced (FIG. 7). Left one is a color image. Middle one is a UV image and right one is a binary image (totally white).

### Experiment 7: Algorithm Detects to High Median Intensity but as Well Areas where the Intensity is Good

### Description

In a test the algorithm detects that the median intensity is lower 70 and therefore increases the conveyer belt. In a production site alternatively the oven temperature could be reduced (FIG. 8). Left one is a color image. Middle one is a UV image and right one is a binary image.

1. Process for the production of glass-fiber paper composites having a desired compressive strength comprising the following steps in sequential order:

2. i. subjecting a non-cured glass-fiber paper composite to a curing process under curing conditions of elevated temperatures and respective dwell time to establish a desired compressive strength within the composite;

3. ii. irradiating the cured composite with light and scanning the cured composite with a respective detector;

4. iii. analyzing the outcome of step ii. by an electronic control unit being programmed to decide whether said curing conditions have to be adjusted or whether further curing of the composite is to be initiated or a reject is detected; and

5. iv. if the curing conditions have to be adjusted based on the data generated under iii. adjust the time of the curing process in an automatic closed-loop control format.

6. Process of claim 1,

7. characterized in that

8. the irradiation is performed by a lightning system.

9. Process according to claim 2,

10. characterized in that

11. the irradiation is performed at minimum one wavelength.

12. Process according to one of the preceding claims,

13. characterized in that

14. the detector for scanning the composite is selected from the group of line scanners, cameras.

15. Apparatus for performing the process of anyone of the preceding claims comprising:

16. a. device for heat treating a glass-fiber paper composite;

17. b. a light emitting device;

18. c. a respective detector for scanning the composite;

19. d. an electronic control unit which is programmed to analyze the outcome of step c. in a sense to decide whether said curing conditions have to be adjusted or whether further curing of the composite is to be initiated or a reject is detected,

20. wherein the apparatus is arranged to adjust the time of curing process based on the data generated under d. in an automatic closed-loop control format.
